(19) United States
(12) Patent Application Publication
(10) Pub. No.: US 2020/0242531 A1
(43) Pub. Date: Jul. 30, 2020

(54) Chat-related customer behaviour scoring system allowing to classify customer performance based on predefined conditions and qualifiers

(71) Applicant: Krzysztof Górski, Wroclaw (PL)

(72) Inventor: Krzysztof Górski, Wroclaw (PL)

(21) Appl. No.: 16/258,784

(22) Filed: Jan. 28, 2019

(51) Int. Cl. G06Q 10/06; G06Q 30/00; G06Q 30/02; G06F 9/54

(52) U.S. Cl. CPC G06Q 10/06393; G06F 9/547; G06Q 30/0281; G06Q 30/016

(57) ABSTRACT

The embodiment creates a customer behaviour scoring system allowing to estimate customer performance. It is organized around so-called goals which serves as assessment metrics. The metrics can be custom made and tailored in line with the embodiment user needs. It uses the three different methods based on URLs, API calls and custom variables to assess web page or application visitor's activity. The embodiment uses conditions set up in the backend infrastructure to verify if certain action should be counted as goal and it displays it in the form of reports presenting customer behaviour. This system shall serve as a support to online assessment of customer performance.

### BACKGROUND

The embodiment relates to the need of customer performance scoring. This application is related to some prior art that presently appears relevant as part of the embodiment employs a method disclosed by U.S. Pat. No. 6,502,133 B1 entitled “Real-time event processing system with analysis engine using recovery information” and U.S. patent application Ser. No. 09/276,340 entitled “Real-Time Event Processing System with Subscription Model,”. The embodiment differs from the related prior art as it presents the solution which addresses not only to real-time processing but builds a comprehensive solution which introduces goals system concerning chat and chat-related performance. It goes beyond typical purchase based assessment and extends to different forms of scoring as individual API calls or non-monetary actions. Furthermore, the embodiments stand as different from Pat. US20080177600A1 “Methods and systems for measuring online chat performance” as the embodiment constitutes a method which applies not only to score sale system but also to set up personalized assessments which shall define it the activity of a user may be classified as meeting criterions. What is more, the embodiment is not necessarily related to the opening of a chat conversation. The main assumption of the invention is to become a subsidiary source assisting in customer acquisition and performance not necessarily leading to a chat conversation, Nevertheless, it remains with communication with the chat database and uses code installed on the web page to provide some parameters of customer scoring.

The embodiment constitutes a method and complex solution suited for internet business. It allows scoring of a performance of customers basing on. URLs, custom variables, pre-defined conditions or subjective API calls. The innovative aspect of the embodiment is that it not only allows to aggregate and score certain actions of web page visitors but it also abandons the common idea of scoring defined only by sale performance. The embodiment is prepared to meet different, more complex needs of users which may be interested not only in the sale or its lack but also on certain behaviour, interest level or what actions brought the user to perform any desired action on the webpage. It allows automating lead scoring system with the only manual necessary input being set up of conditions and triggers to classify actions.

### SUMMARY

The embodiment provides a method and solution for customer performance assessment. It allows creating a scheme allowing to classify if customer achieved fixed goal saved in the database and process such action in a real-time manner. The embodiment offers three different methods of goal triggering based on following criterions (1)URL from which goal was collected, (2) custom variable saved in the database or sales tracker method or (3) API call. Variety of methods allows to extend goal collection beyond the typical purchase based assessment process and provides a comprehensive methodology to assess customer performance based on its interests, visits or any other subjective triggers. The solution is designed to cooperate with an in-web page or in-web application chats, it uses the code installed on the web page to collect goals based on the relation between agent-customer conversation and customer performance. The embodiment works in a complementary manner with different languages like Javascript, VBScript, AJAX and XML. The embodiment provides a method of communication between backend processing, frontend presentation of data and real-time processing.

### DESCRIPTION OF DRAWINGS

FIG. 1—Provides a general flow of data in the embodiment with web page visitor and conditions used to assess goal achievement.

FIG. 2—Provides an advanced overview of communication between chat solution with the embodiment implemented, backend databases and frontend.

FIG. 3—Shows classes of goal triggers with internal division of custom variables method (classic application and sales tracker).

FIG. 4—Shows goal trigger based on URL flow.

FIG. 5—Shows goal trigger based on API call as independent subjective trigger.

FIG. 6—Provides an overview of differences between custom variable triggers and sales tracker triggers in case of goal collection.

FIG. 7—Provides an example ofISON query and response in case of sales tracker usage.

### DETAILED DESCRIPTION

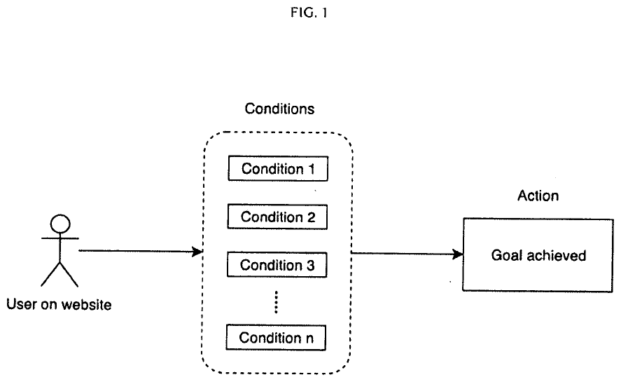

The embodiment constitutes a solution which addresses the issue of online customers (or web page visitors) scoring. It enables not only assessment of the sale process but also to create more sophisticated parameters which may be customized based on individual user needs. Despite a vital role played by chat database, the embodiment recognition system is much wider than only chat-based system. It allows scoring regardless of active chat conversation presence. In fact, different web pages and businesses may require different: conditions (individual or collective) with some of those being triggered by subjective criterions as API call. The embodiment faces the issue of multiple conditions in a manner presented by FIG. 1. In a very simplified form, the main objective of the embodiment is to match action of the user on a web page with conditions (unlimited in its kind) to classify certain action as a goal achieved or not. The embodiment provides not only the plain idea of the scoring system but also backend infrastructure and the scheme of backend-frontend communication. As the outcome of the embodiment, it allows generating a report through its interface which summarizes not only positive conversions but also performance scoring and behaviour or visitors.

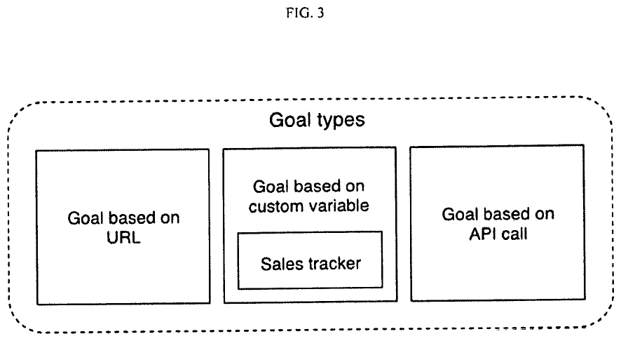

The embodiment offers three main types of goals with one of them having two subclasses based on similar logic, those main goals types are as follows, FIG. 3:

(1) URL-based goal—classified upon, for example, visit on defined landing page. Such landing page may be associated with post-sale step but is not limited to this idea. In fact, this goal may be fulfilled by any chosen URL pre-defined as a triggering condition.

(2) Custom variable based goal—defined in the code embedded on the web page. In this category, one can differentiate the application of the embodiment in a complementary way with any chat solution. In such case, the goal may be used to measure conversation effectiveness.

(3) Goal based on API call—this option allows to include any subjective goal classification as in this case, the only condition which shall be met is the API call sent by the integrated software that certain acts shall be counted as an achieved goal.

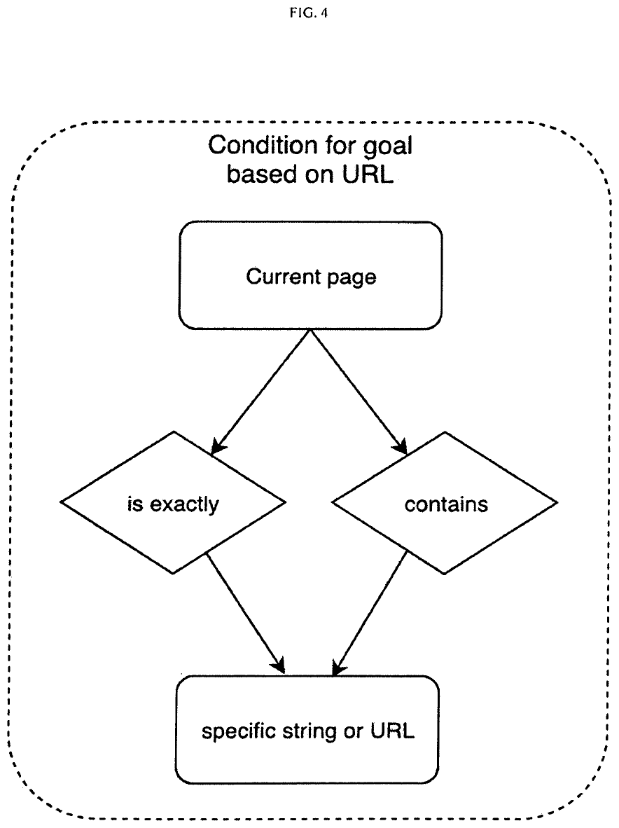

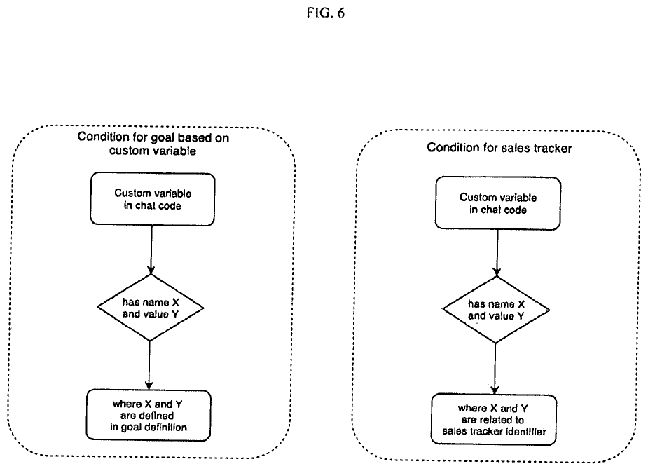

Abovementioned elements provide a solution which allows establishing complex and well-suited triggers to collect goals. By mean of example, URL-based goal may work in a way presented by FIG. 4 which depicts simplified goal detection scheme. Recognition of a goal is counted upon URL which may be defined either in its entire form (is exactly) or upon certain elements which it contains. Such a goal may be used to define the selling process or to assume that visiting certain webpage is a success and shall be counted as a goal. The next type of goal is triggered by the custom variable. This element is particularly dependent upon chat due to the fact that it collects goals upon code installed on the webpage. The logic responsible for goal triggering counts a goal once web page with code installed is viewed and name X and value Y fulfill conditions which are saved in the database. it is notably important to highlight that the category of goals based on custom variables is a wider class which includes goals based on conditions for sales tracker. Comparison of flows in case of usual variable condition and sales tracker is depicted by FIG. 6, where it is shown that the main difference between those two modules occurs at the very last stage where in case of usual usage of custom variables, a goal is based upon information saved in the database and in case of sales tracker upon sales tracker identifier. Such identifier is made upon a code installed on the web page included in the code of said page just before ending </body>HTML code. As sales tracker is entirely dedicated to address what can be broadly understood as customer performance scoring effectiveness provided through the chat solution, this part of the embodiment allows to implement tracking in a form of three different methods, namely:

1) Static—counts goal basing on the number of certain actions. Regardless of the purchase value, the chat will be credited the same, set amount every time. It is based upon a simple sum of elements which have been purchased and the rule that every purchase is worth the same.

(2) Dynamic—a method designed to provide a monetary assessment based on a value which shall be especially practical once implemented in the e-commerce cart after a purchase.

(3) Non-Monetary—used to assess goal collection based not on the value of object but on the fact of sale, such method may be applied in case of conversion of customers, for example in case of Software as a Service (SaaS) companies. It allows not to assign any specific value to a chat but it is still possible to tie it the purchase property to the conversation.

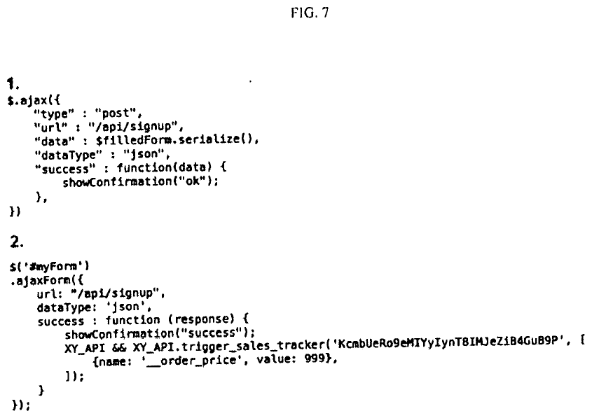

Sales Tracker option possess also the possibility to communicate and trigger goal via API in case of dynamically inserted code. In this case, FIG. 7 presents API request and response which allows collecting goal. FIG. 7 part 1. presents a sample of a request made upon purchase by the customer through a web page with the embodiment implemented. FIG. 7 part. 2 presents the response through API in case of successful action—the response itself contains a string related to sales tracker itself trigger_sales_tracker. Such callback serves as a substitute application of the idea of sales tracker to trigger goal. In case of any usage of sales tracker, the user of the embodiment is allowed to set up a lifetime of the attribution. It means that in case of sale process from a particular period of time it shall be associated with particular chat interaction. It allows defining time scope up to implemented value.

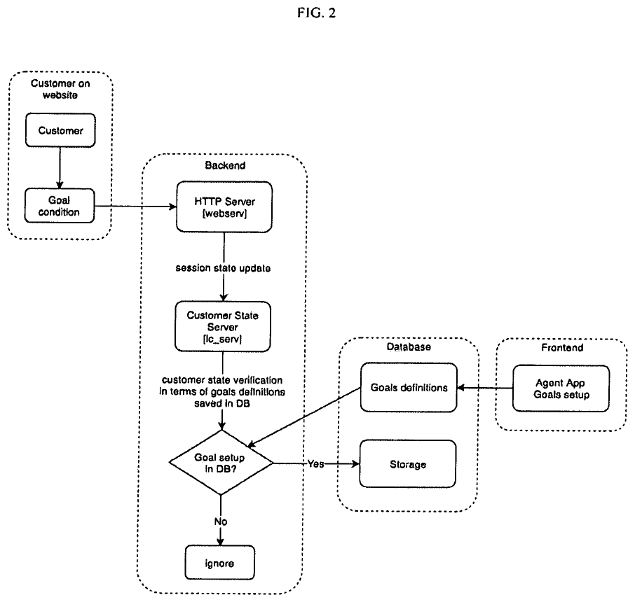

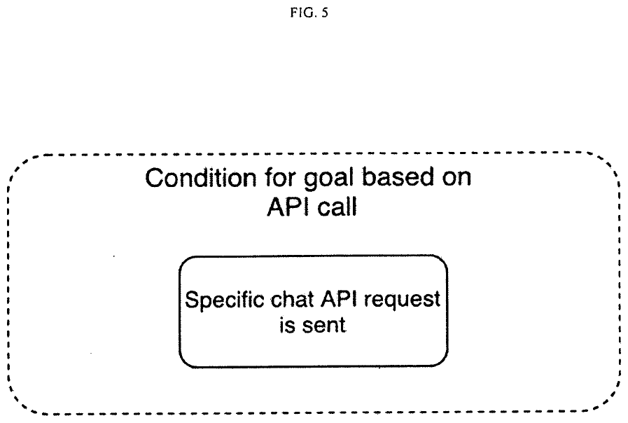

The last predefined form of goal collection concerns API communication. Goals based on API calls provide a solution which may subjectively collect a goal. Contrary to previous methods, it ensures full freedom of choice for the user of the embodiment due to the fact that application may communicate with the embodiment and decide upon goal collection whenever a request is received. Above described goal trigger is described by FIG. 5 and it clearly depicts that the goal is counted based on individual API-originated information. The fact that the embodiment includes three different methods of goal triggering implemented as complementary ensures that is can cover broad needs not only purchase related but also customer performance and customer success related. This broad application of the embodiment is supported by both backend and frontend communication adjusted by real-time processing. FIG. 2 presents how elements of the embodiment interact. The core elements of the embodiment are backend infrastructure which is framed upon the interaction between the Customer State Server and HTTP Server. To ensure proper qualification of a goal, the embodiment user needs to provide a goal definition and saved it in the database (FIG. 2). Once such condition is set up and particular action is analyzed, the embodiment checks if it fulfills minimum triggering qualifiers and if yes. decides upon collection in the storage space of the database. If the action taken by the web page visitor does not meet the necessary minimum triggering criterions the action is dropped and there is no saved record. Set up of database conditions shall be allowed through an interface which provides a user-friendly interface with dedicated space to introduce parameters. Such structure shall allow accessibility for agents which are in direct contact with web page visitors with no requirement of technical knowledge after the embodiment is properly integrated.

The embodiment may be applied on both web pages and online applications (operating through browsers). Furthermore, while reference may be made to certain programming languages, such as, for example, JavaScript is a scripting language that is typically executed by an integrating client-side application, other types of programming languages may be used as well. The embodiment shall be operational with other languages as e.g., VBScript. AJAX (aSynchronous JavaScript and XML). The embodiment is adequate and can be implemented with different chat solutions, for example, but not limited to any chat relay or live chat products. The website with chat embedded can include one or more Web servers that accepts HTTP requests from clients, such as web browsers, and serves HTTP responses in addition to optional data contents, such web pages (e.g., HTML documents and linked objects, such as images). and that receive user inputs. The database is in a real-time processing relation what shall provide no communication delays between factual goal occurring and a goal scored detection.

What is claimed:

1. The method of automated customer performance evaluation composed out of the following parts:
a. set up in the database of a triggering qualifier which allows determining goal classification,
b. abovementioned triggering qualifiers shall be based upon three independent methods, namely URL recognition, custom variables and API calls:
c. programmatically determining of a goal collects it in a backend structure and displays through the frontend interface:
d. information is collected by independent system communicating with HTTP server and code installed in the webpage structure.

2. The method according to claim 1, wherein:
a. An interaction between the chat code and the programmatically-determined context has been specified by the intended action undertaken by the webpage visitor what triggers goal collection;
b. custom variable claimed by p. 1(b) may include chat effectiveness assessment constructed upon a plurality of visitors reactions and conversion upon interaction with an agent through chat

3. The method as defined in claim 1, the method further comprising:
a. Defining a subset of visitors which meet criterions set up in the database and providing either collection in case of positive fulfilment of criterions or action dropped in case of a mismatch.
b. Containing the channel which ensures communication between frontend and backend and functional API which communicates the embodiment with external applications;
c. receiving initial data indicating which visitors in the first subset of visitors were converted via the website during the first period of time and association of such data with the scoring system.
